(19) United States
(12) Patent Application Publication
(10) Pub. No.: US 2026/0300068 A1
(43) Pub. Date: Oct. 1, 2026

(54) MACHINE LEARNING MODEL PARAMETER TRANSFER

(71) Applicant: Lenovo (United States) Inc., Morrisville, NC (US)

(72) Inventor: Venkata Srinivas Kothapalli, Aurora, IL (US)

(73) Assignee: Lenovo (United States) Inc., Morrisville, NC (US)

(21) Appl. No.: 19/097,705

(22) Filed: Apr. 1, 2025

(51) Int. Cl. G06F 11/07

(52) U.S. Cl. CPC G06F 11/0754; G06F 11/0712

(57) ABSTRACT

Various aspects of the present disclosure relate to a node for wireless communication, comprising: at least one memory; and at least one processor coupled with the at least one memory and operable to cause the node to: obtain a machine learning (ML) model comprising of a set of model parameters; for each model parameter in the set of model parameters, determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond a tolerance threshold value; and transmit the error protected model parameters to a further node.

### TECHNICAL FIELD

The present disclosure relates to wireless communications, and more specifically to a technique to transfer parameters of a machine learning model from one node to another node over a communications network.

### BACKGROUND

A wireless communications system may include one or multiple network communication devices, which may be otherwise knowns as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A node of a wireless communications system (e.g., a network communication device or a user communication device) may transfer a machine learning model to another node of the wireless communications system (e.g., a network communication device or a user communication device).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Implementations of the method and apparatuses described herein may include a node for wireless communication, comprising: at least one memory; and at least one processor coupled with the at least one memory and configured to cause the node to: obtain a machine learning (ML) model comprising of a set of model parameters; obtain a set of data samples for inputting to the ML model; determine a maximum change to the set of model parameters that is permitted without performance of the ML model degrading beyond a tolerance threshold value; quantize, based on the determined maximum change, the set of model parameters to generate quantized model parameters; and transmit the quantized model parameters to a further node.

In some implementations of the method and apparatuses described herein, the maximum change to the set of model parameters that is permitted without performance of the ML model degrading beyond a tolerance threshold value is represented by an error vector.

In some implementations of the method and apparatuses described herein, the at least one processor is configured to cause the node to: (i) determine first output values of the ML model when the set of data samples are input into the ML model having initial values for the set of model parameters; (ii) arrange the initial values of the set of model parameters into a parameter vector; (iii) generate a perturbed parameter vector by adding an error vector to the parameter vector; (iv) determine second output values of the ML model when the set of data samples are input into the ML model having values of the perturbed parameter vector for the set of model parameters; (v) compute a set of difference values, each difference value being a norm of a difference between the second output value and the first output value for a respective data sample of the set of data samples; (vi) compute an average of the set of difference values; and (vii) determine that the error vector represents the maximum change if the average of the set of difference values equals or exceeds the tolerance threshold value.

In some implementations of the method and apparatuses described herein, the norm of the error vector is equal to a step size parameter, and if the average of the set of difference values is less than the tolerance threshold value, the at least one processor may be configured to cause the node to increase the value of the step size parameter and optionally repeat steps (iii)-(vii).

In some implementations of the method and apparatuses described herein, the at least one processor is configured to cause the node to determine an initial value for the step size parameter, or receive an initial value for the step size parameter, or receive an indication of an initial value for the step size parameter, from another node.

In some implementations of the method and apparatuses described herein, the at least one processor is configured to determine a tolerance range for the set of model parameters by computing a norm of the error vector, and perform the quantization such that a norm of a difference between a quantized version of the model parameters and the model parameters is less than or equal to the tolerance range.

In some implementations of the method and apparatuses described herein, the at least one processor is configured to compute an absolute value of each element in the error vector; and if the absolute value of an element in the error vector is greater than a sensitivity threshold value, declare a corresponding model parameter in the parameter vector as a non-sensitive model parameter; and if the absolute value of an element in the error vector is less than or equal to the sensitivity threshold value, declare a corresponding model parameter in the parameter vector as a sensitive model parameter; wherein the at least one processor is configured to quantize the sensitive model parameters with a higher resolution than a resolution used to quantize the non-sensitive model parameters.

In some implementations of the method and apparatuses described herein, the at least one processor is configured to determine a tolerance range for the set of model parameters by computing a norm of the error vector, and quantize each model parameter of the set of model parameters using the same resolution that is based on the tolerance range.

In some implementations of the method and apparatuses described herein, the at least one processor is configured to cause the node to receive the set of data samples from another node.

In some implementations of the method and apparatuses described herein, the at least one processor is configured to obtain the set of data samples based on reference signals received from another node.

In some implementations of the method and apparatuses described herein, the at least one processor is configured to determine the tolerance threshold value.

In some implementations of the method and apparatuses described herein, the node is configured to receive the tolerance threshold value or an indication of the tolerance threshold value, from another node.

In some implementations of the method and apparatuses described herein, the node is a user equipment, network equipment or a server.

In some implementations of the method and apparatuses described herein the at least one processor is configured to: compute an absolute value of each element in the error vector; if the absolute value of an element in the error vector is greater than a sensitivity threshold value, declare a corresponding model parameter in the parameter vector as a non-sensitive model parameter; if the absolute value of an element in the error vector is less than or equal to the sensitivity threshold value, declare a corresponding model parameter in the parameter vector as a sensitive model parameter; and error control code each quantized model parameter in the set of quantized model parameters with an error control code, wherein a rate of the error control code is determined based on whether the model parameter is a sensitive model parameter or a non-sensitive model parameter.

In some implementations of the method and apparatuses described herein a rate of the error control code for the sensitive model parameters is less than the rate of the error control code for the non-sensitive model parameters.

In some implementations of the method and apparatuses described herein the set of data samples are unlabeled.

Implementations of the method and apparatuses described herein may include a processor for wireless communication, comprising: at least one controller coupled with at least one memory and configured to cause the processor to: obtain a machine learning (ML) model comprising of a set of model parameters; obtain a set of data samples for inputting to the ML model; determine a maximum change to the set of model parameters that is permitted without performance of the ML model degrading beyond a tolerance threshold value; quantize, based on the determined maximum change, the set of model parameters to generate quantized model parameters; and output the quantized model parameters for transmission to a further node.

Implementations of the method and apparatuses described herein may include a method performed at a node, the method comprising: obtaining a machine learning (ML) model comprising of a set of model parameters; obtaining a set of data samples for inputting to the ML model; determining a maximum change to the set of model parameters that is permitted without performance of the ML model degrading beyond a tolerance threshold value; quantizing, based on the determined maximum change, the set of model parameters to generate quantized model parameters; and transmitting the quantized model parameters to a further node.

Implementations of the method and apparatuses described herein may include a node for wireless communication, comprising: at least one memory; and at least one processor coupled with the at least one memory and configured to cause the node to: obtain an ML model comprising of a set of model parameters; for each model parameter in the set of model parameters, determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond a tolerance threshold value; and transmit the error protected model parameters to a further node.

In some implementations of the method and apparatuses described herein the at least one processor is configured to: (i) determine first output values of the ML model when a set of data samples are input into the ML model having initial values for the set of model parameters; (ii) arrange the initial values of the set of model parameters into a parameter vector; (iii) generate a perturbed parameter vector by adding an error vector to the parameter vector; (iv) determine second output values of the ML model when the set of data samples are input into the ML model having values of the perturbed parameter vector for the set of model parameters; (v) compute a set of difference values, each difference value being a norm of a difference between the second output value and the first output value for a respective data sample of the set of data samples; (vi) compute an average of the set of difference values; and (vii) if the average of the set of difference values equals or exceeds the tolerance threshold value: the at least one processor is configured to compute an absolute value of each element in the error vector; and (viii) if the absolute value of an element in the error vector is greater than a sensitivity threshold value, declare a corresponding model parameter in the parameter vector as a non-sensitive model parameter; and (ix) if the absolute value of an element in the error vector is less than or equal to the sensitivity threshold value, declare a corresponding model parameter in the parameter vector as a sensitive model parameter.

In some implementations of the method and apparatuses described herein the at least one processor is configured to cause the node to: error control code each model parameter in the set of model parameters with an error control code, wherein a rate of the error control code is determined based on whether the model parameter is a sensitive model parameter or a non-sensitive model parameter.

In some implementations of the method and apparatuses described herein a rate of the error control code for the sensitive model parameters is less than the rate of the error control code for the non-sensitive model parameters.

In some implementations of the method and apparatuses described herein a norm of the error vector is equal to a step size parameter, and if the average of the set of difference values is less than the tolerance threshold value, the at least one processor may be configured to increase the value of the step size parameter and optionally repeat steps (iii)-(x).

In some implementations of the method and apparatuses described herein the at least one processor is configured to determine an initial value for the step size parameter.

In some implementations of the method and apparatuses described herein the at least one processor is configured to receive an initial value for the step size parameter or an indication of an initial value for the step size parameter, from another node.

In some implementations of the method and apparatuses described herein the norm of the error vector is an Euclidean norm.

In some implementations of the method and apparatuses described herein the at least one processor is configured to determine the tolerance threshold value.

In some implementations of the method and apparatuses described herein the node is configured to receive the tolerance threshold value or an indication of the tolerance threshold value, from another node.

In some implementations of the method and apparatuses described herein the at least one processor is configured to determine the sensitivity threshold value.

In some implementations of the method and apparatuses described herein the at least one processor is configured to receive the sensitivity threshold value or an indication of the sensitivity threshold value, from another node.

In some implementations of the method and apparatuses described herein the node is a user equipment, network equipment or a server.

In some implementations of the method and apparatuses described herein the set of data samples are unlabeled.

Implementations of the method and apparatuses described herein may include a processor for wireless communication, comprising: at least one controller coupled with at least one memory and configured to cause the processor to: obtain an ML model comprising of a set of model parameters; for each model parameter in the set of model parameters, determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond a tolerance threshold value; and output the error protected model parameters for transmission to a further node.

Implementations of the method and apparatuses described herein may include a method performed at a node, the method comprising: obtaining an ML model comprising of a set of model parameters; for each model parameter in the set of model parameters, determining a sensitivity of the model parameter, and providing error protection to the model parameter based on the sensitivity of the model parameter, the sensitivity of the model parameter indicating a degree of toleration for a value of the model parameter to vary without performance of the ML model degrading beyond a tolerance threshold value; and transmitting the error protected model parameters to a further node.

### BRIEF DESCRIPTION OF THE DRAWINGS

FIG. 1 illustrates an example of a wireless communications system in accordance with aspects of the present disclosure.

FIG. 2 illustrates an example of a node 200 in accordance with aspects of the present disclosure.

FIG. 3 illustrates an example of a processor in accordance with aspects of the present disclosure.

FIG. 4 illustrates a flowchart of method 400 performed by a node 200 in accordance with aspects of the present disclosure.

FIG. 5 illustrate a flowchart of a further method 500 performed by a node 200 in accordance with aspects of the present disclosure.

### DETAILED DESCRIPTION

A wireless node (e.g., a device in a wireless network) may transfer an artificial intelligence (AI)/machine learning (ML) model (otherwise referred to herein as an ML model) over a wireless network. This task of transferring an ML model from one node to another node is referred to herein as model transfer. Model transfer, in the case when the ML model is or relates to a Deep Neural Network (DNN), corresponds to transferring all the DNN parameters comprising of parameters (weight and/or bias) of each neuron in the neural network, values of affine parameters of its normalization layers (if any), and/or other information relating to its activation functions and/or the architectural details of the DNN.

During the event of a model transfer, the parameters of the ML model (i.e., edge weights, biases of neurons, along any affine parameters of the normalization layers) that are represented by w₁, . . . , w_{N}, constitute a major fraction of information to be transferred over a wireless network. In some examples, wᵢ∈ [symbol] , i=1, . . . , N, means that parameter values can assume any value over the real line. To send such parameter values over a communication channel, the values are quantized and expressed in binary using a finite number of bits. Wireless channels in wireless networks may often be noisy and transmitted messages in such wireless network are prone to distortions and errors due to multiple imperfections in the transmit-receive chain hardware units and distortions introduced by the physical channel. In such cases, the bits representing each parameter are protected using Forward Error Correction (FEC).

FEC comprises adding redundant bits to the information bits in such a way that the information bits can be reliably decoded at the receiving end even when some of the transmitted bits are flipped/corrupted during the transmission. Thus, transferring a ML model (e.g., a DNN model), which comprises transmitting its model parameters, involves quantization of the model parameters w₁, . . . , w_{N}, and protecting the quantized parameter values by adding redundancy through FEC.

Even for a single task to be performed by a ML model, model transfer is not likely to be a onetime affair. A network node may update a ML model and transfer the updated model parameters to another node over the wireless network. Thus, model transfer can consume a significant amount of wireless network resources.

Another situation where quantization of the model parameters of a trained ML model becomes an important aspect is the following. It can be understood that, performing computations involving all integer valued parameters (i.e., having a finite precision) would be easier than performing computations involving real numbers that require an infinite, or long decimal expansion. While implementing algorithms/methods/procedures/AI models involving real numbers (i.e., numbers that require an infinite decimal expansion) it is a common practice to represent the real numbers with floating point numbers. For example, quantizing real numbers to 32-bit floating-point numbers is a common practice in practical implementation of algorithms/methods/procedures/AI models whose parameter values are given by real numbers. Quantizing real numbered parameters to a finite-precision may result in losing the precision/accuracy in the output, but, often, a close approximation to the actual output suffices.

Thus, regarding implementation of a ML model, quantizing real-valued parameters to a finite-precision has, at least, two advantages: (i) it takes lower storage space (e.g. in memory) to store the ML model and reduces the signaling overhead in transferring the ML model over a communication network; (ii) the inference/prediction using the ML model would be faster as the computations involves finite-precision arithmetic rather than infinite-precision arithmetic.

Hence, quantization of the parameters of a ML model and the amount of error protection given to each parameter during model transfer over wireless channel would affect the amount of information/number of bits that need to be transmitted over the wireless channel for model transfer. Further, quantization of the parameters of an ML model is an important aspect in practically putting them to use in wireless networks, as, it will affect the amount of storage space required to store the ML model, and it will affect the speed of computations performed by the ML model during inference.

Quantization of the parameters will affect the prediction/inference performance of the ML model. Some implementations of the present disclosure relate to determining a maximum change to the set of model parameters that is permitted without performance of the ML model degrading beyond a tolerance threshold value and quantizing the model parameters based on this determined maximum change. Thus, quantization of the model parameters is performed while ensuring that the model performance does not degrade beyond the tolerance threshold value.

Some implementations of the present disclosure relate to identifying the sensitivity of different parameters of the ML model, and providing a higher level of error protection to the highly sensitive parameters and a lower level of error protection to the parameters having lesser sensitivity (or lesser influence on the model prediction). As the amount of redundancy and, hence, the number of bits to be transmitted will increase with the amount of error protection, this unequal error protection can advantageously achieve an optimal/desired trade-off inference performance of the ML model and the amount of error protection that is added.

Thus, the methods disclosed herein enables reducing the signaling overhead through informed quantization of, and/or unequal error protection for, ML model (e.g., a DNN) parameters without the need for training data and labelled data.

Aspects of the present disclosure are described in the context of a wireless communications system.

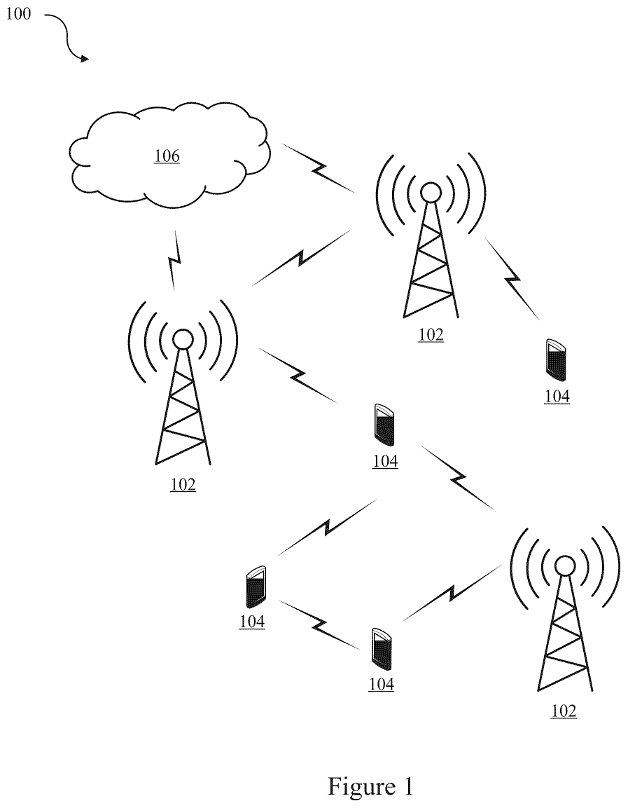

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Implementations of the present discourse relate to the transmission of model parameters of a ML model from a node (first node) to a further node (second node).

The node may correspond to a network node e.g., NE 102 shown in FIG. 1, a user communication device e.g., UE 104, or a node in the CN 106. The node may alternatively correspond to a server (or other computing device) not shown in FIG. 1 that is coupled to the wireless communications system 100. For example, the node may correspond to a computing device in a laboratory or R&D facility of a network vendor, or a computing device of a UE vendor, a computing device of a company that develops and sells ML models to the wireless network industry. The further node may correspond to a network node e.g., NE 102 shown in FIG. 1, a user communication device e.g., UE 104, or a node in the CN 106.

The ML model receives an input and generate an output, e.g., a predicted output, based on the received input and on values of model parameters of the model. The ML model may be a deep model that employs multiple layers of models to generate an output for a received input. For example, a deep neural network (DNN) is a deep machine learning model that includes an output layer and one or more hidden layers that each apply a non-linear transformation to a received input to generate an output.

Let xᵢ∈X and yᵢ∈ [symbol] denote an input sample and the corresponding label (equivalently, expected output sample, or expected prediction/inference from the ML model for input xᵢ). Here, xᵢ can be a scalar or a vector or a matrix or a tensor (i.e., xᵢ is a scalar or a one or multi-dimensional vector) and, similarly, yᵢ is a scalar or a vector or a matrix or a tensor. X and [symbol] denote the input sample space and the output sample space, respectively. When yᵢ assumes discrete and finitely many values, then the ML model is called a classifier model. When yᵢ assumes continuous values with [symbol] = [symbol] (or [symbol] = [symbol] ) then the ML model is referred to as a regression model. An ML model is essentially a mapping or, a function ƒ_{W}:X→ [symbol] , where

$$W = {\{ {w}_{i} \}}_{i = 1}^{N}$$

denotes the set of model parameters that are learned during the process of training the model.

The ML model can be an algorithm comprising learnable parameters (such as a support vector machine, or a decision tree). Taking the example whereby the ML model comprises an epsilon-greedy sequential learning algorithm, the model parameters may comprise epsilon and/or a parameter indicating the number of iterations. In another example whereby the ML model belongs to a class of random forest algorithms, the number of nodes and branches and how a particular branch is chosen at each node defines the ML model. Thus, in this example, the model parameters may comprise a threshold value at each node, the number of nodes and/or the number of branches.

The ML model can be a neural network (e.g., a DNN), and the model parameters may comprise: one or more edge weights, one or more bias values, one or more value of affine parameters of its normalization layers (if any), one or more activation function parameter, and/or one or more parameter defining the architectural details of the neural network (e.g. number of layers).

An ML model can be deployed to a wireless network for different purposes, such as for Channel State Information (CSI) estimation, CSI compression, beam prediction, and positioning (e.g., to locate a UE).

An ML model is developed by training the model over one or more data sets. The data sets can be either labelled or unlabeled, leading to supervised training/learning or unsupervised/self-supervised training/learning, respectively. In the case of ML models for wireless communications, the models may be developed based on training and testing with data sets constructed either from simulated data or from the real-world data collected from functioning wireless networks or a combination of both simulated and real-world data.

Without loss of generality, consider developing an ML method through supervised learning (noting that implementations of the present disclosure are applicable to ML models developed through unsupervised learning and/or self-supervised methods). Let data samples

$${𝒟}_{tr} = {\{ ( {x}_{i} , {y}_{i} ) \}}_{i = 1}^{{N}_{t r}}$$

denotes the set of labelled training data samples, where xᵢ∈X and yᵢ∈ [symbol] denote an input sample and the corresponding label, or, equivalently, expected output sample from ML model for input xᵢ As depicted herein, yᵢ is also known as the prediction for input xᵢ. In unsupervised/self-supervised learning, the training data set would be an unlabeled data set

$${𝒟}_{tr} = {\{ {x}_{i} \}}_{i = 1}^{{N}_{t r}} .$$

An ML model can be considered as a mapping or, a function, ƒ_{W}, where ƒ_{W}:X→ [symbol] . Here,

$$W = {\{ {w}_{i} \}}_{i = 1}^{N}$$

denotes the set of optimal model parameters that are learned during the process of training the model. Determining the optimal values of model parameters, i.e., determining W using the data set [symbol] is referred to as the “training the model” or “learning the model”. The general procedure of supervised learning/training of an ML model comprises minimizing a loss function L. More precisely, the set of optimal parameters (W) is determined by solving the following optimization problem:

$$W = {min}_{{W}^{′} ∈ {ℝ}^{N}} L ( {W}^{′} , {𝒟}_{tr} )$$

The learned/trained model, (or, equivalently, the mapping) ƒ_{W}, (especially when the underlying ML model is a DNN) generates a probability distribution P(y|x; W) over the predictions y, conditioned on the input x and parameterized by W, and the conditional distribution is differentiable in W. Thus, the trained DNN, after training on a data set [symbol] , generates a probability distribution P(y|x; W) that is differentiable in W.

When the task is classification, output space contains finitely many values, and the cardinality of the set [symbol] is finite. Hence, y is a discrete variable with y∈{y₁, . . . , y_{c}} and P(y|x; W) is the probability that y is the predicted label for x under the model parameters W. In other words, P(y_{c}|xᵢ; W) is the probability that y_{c} is the label/prediction/class (with c∈{1, . . . , C}) for the given input xᵢ, as per the prediction/inference made by the DNN with W as its model parameters. In this example,

$${\sum }_{c = 1}^{C} P ( {y}_{c} \vert {x}_{i} ; W ) = 1 ,$$

or, equivalently, Σ_{y}_{_{c}}_{∈{y}_{₁}_{, . . . ,y}_{_{c}}_{}} P(y_{c}|xᵢ; W)=1.

On the other hand, when the expected output, or the expected prediction or the expected inference yᵢ for an input xᵢ is a continuous valued real number, i.e., when yᵢ∈ [symbol] , the task being performed is referred to as regression and the ML model is called a regression model.

In a trained DNN, with the optimal model parameters given by W=[w₁, . . . , w_{N}]^{T}∈ [symbol] , the prediction/inference performance of the DNN is more sensitive to some of the parameters in w₁, . . . , w_{N} than the other parameters. In other words, some of the parameters play a more important role in deciding the output of the DNN. When the value of a sensitive parameter in a DNN is changed even by a small amount from its optimal value (i.e., learned/trained value), there will be a significant change in the DNNs prediction/inferences. At the same time, some of the parameters of the DNN are not very sensitive, meaning that the DNN's prediction/inference performance is relatively robust to changes in the values those parameters.

Assume that we have modified the optimal parameter vector W to produce a parameter vector Ŵ, where Ŵ=W+E, where E is an error or a perturbation vector of the same size as that of W. The prediction/inference performance of ML model with Ŵ as its parameters would be inferior compared to the ML model with W as its parameters; In other words, the performance of ƒ_{Ŵ} would be inferior to the performance of ƒ_{W}. If the performance of ƒ_{Ŵ} is still acceptable, i.e., if the performance of ƒ_{Ŵ} is not lower than a certain level/threshold when compared with the performance of ƒ_{W}, then the vector E represents an acceptable/tolerable change in the parameter values of the DNN under consideration, from its optimal values.

The inventor has observed that if sensitive parameters that are highly influential in determining the prediction/inference performance of the ML model can be identified then quantization of the ML model parameters can be performed such that the sensitive model parameters can be quantized with a high precision/high resolution quantizer, and the remaining parameters are quantized with a low precision/low resolution quantizer. In other words, sensitive model parameters are represented by a larger number of bits and the other (not-so-sensitive) parameters are represented with lower number of bits. This would potentially minimize the total number of bits needs to represent the DNN parameters, while ensuring desired level of inference performance.

Existing methods of quantizing ML model parameters require the training data set [symbol] or, at least, a labelled data set to determine the sensitivity of, or tolerance range for, the learned/trained parameters of the ML model. However, knowing the training data set is difficult in some situations. For example, a Parametric Server (PS) performing model aggregation in a federated learning setting will not have access to the training data, but it must transfer the aggregated model parameters back to the users participating in the federated learning process. In another example, consider a situation where an ML model is developed by a third party (e.g., a company specialized in developing ML models that is a not a UE or a network vendor) and supplied to a network operator to deploy the model either at a network node (e.g., gNB) or at one or more edge devices (e.g., UEs). Practically, it is difficult for the third party to supply the training data used to develop the model to its customer purchasing the ML model due to privacy concerns and due to the cost incurred in sharing training data sets. At the same time, the network operator purchasing the ML model might want to quantize the parameters of the ML model before deploying it on resource (e.g., memory, computational complexity) constrained devices, such as edge nodes, while ensuring that inference/prediction performance of the ML model does not degrade beyond a certain limit due to quantization of its parameters.

Such scenarios need a method that allows determining the sensitivity, or tolerance range of the ML model parameters, without having access to the training data set or, in general, a labelled data set. Implementations of the present disclosure do not require access to the training data set or, a labelled data set.

The inventor has also observed that if sensitive parameters that are highly influential in determining the prediction/inference performance of the ML model can be identified then sensitive parameters can be provided with more protection against channel corruption and noise by employing low-rate error control codes, while other parameters can be sent over the channel with relatively lower levels of protection by employing higher rate error control codes. This kind of unequal error protection would optimize the wireless network resources for transferring the model parameters.

As is known to persons skilled in the art, a rate of an error control code may be defined as

$$code rate = \frac{Number of useful information bits}{Total number of bits after coding} .$$

Consider an ML model, which is essentially a mapping or, a function, ƒ_{W}, where ƒ_{W}:X→ [symbol] , where W denotes the set of optimal model parameters that are learned during the process of training the model, X is the input sample space and [symbol] is the output sample space. For convenience, let us denote the set of model parameters as a vector; i.e., instead of treating W as a set, consider W as a one dimensional vector such that W=[w₁, . . . , w_{N}]^{T}∈ [symbol] denotes the vector of optimal model parameters learned during the training process and N is the total number of parameters of the ML model. Superscript T denotes transpose operation.

In a trained DNN, with the optimal model parameters given by W=[w₁, . . . , w_{N}]^{T}, the prediction/inference performance of the DNN is more sensitive to some of the parameters in w₁, . . . , w_{N}. In other words, some of the parameters play a more important role in deciding the output of the DNN.

When we have the labelled data from the same data domain over which the ML model (e.g. DNN) is trained and if we know the loss function used during training the model, we can determine the quantum of change in the loss value with respect to each of the optimal model parameters it is possible to determine what parameters of the model are more influential/important in changing the loss value. However, this procedure requires both the loss function employed during training the model as well as the labelled data from the same data domain over which the model (e.g., DNN) is trained. This knowledge of loss function and labelled data samples may not be available always when the ML model (e.g., a DNN) is deployed at the node for performing inference.

Some implementations of the present disclosure comprise determining the sensitivity of, or an overall tolerance range for, the model parameters model parameters using (e.g., unlabeled) data samples.

Let the ML model (e.g. a DNN) be denoted by ƒ_{W}:X→ [symbol] , where

$$W = {\{ {w}_{j} \}}_{j = 1}^{N}$$

or, equivalently, W=[w₁, . . . , w_{N}]^{T} denotes the set/vector of optimal model parameters that are learned during training the DNN.

Let the set of data samples be denoted x={x₁, x₂, . . . , x_{K}} and let yᵢ=ƒ_{W}(xᵢ) denotes output computed by the ML model with parameters W=[w₁, . . . , w_{N}]^{T} for the input sample xᵢ. yᵢ is referred to as the inference or prediction of the DNN for the input xᵢ.

The node may obtain the data samples by various ways. The node may receive a set of K data samples, K>0, from another node in the wireless communications system 100. Alternatively, the node may obtain the set of K data samples based on reference signals received from another node. Consider an ML model for beam management, for such a ML model, input samples are the measured RSRP or measured L1-SINR values and, based on these input samples, the ML model will determine what is the optimal beam. The RSRP or the L1-SINR values are obtained by the node (e.g., a UE) by measuring the reference signals—in this case, either SSB or the CSI-RS signals. A base station 102 may send an SSB signal over a set of Tx beams (for example, if there are a total of 64 Tx beams, the SSBs are sent only over 16 or 32 beams). The UE 104 may then measure the received power (RSRP) on the beams over which the SSB signals are sent. Thus, the RSRP values (e.g., the data samples to be given to the ML model) are obtained by the UE 104 by measuring the reference signals. Other examples can also be envisaged in the case of ML models for CSI prediction, CSI compression, AI based receiver etc.

Without access to the training data set or a labelled data set and the loss function, implementations of the present disclosure make use of the learned function of the DNN, ƒ_{W}, and DNN output values yᵢ=ƒ_{W}(xᵢ), i=1, . . . , K to determine the sensitivity of, or an overall tolerance range for, the different model parameters of the ML model.

Let Ŵ=W+E=[w₁+e₁, . . . , w_{N}+e_{N}]^{T} denote a perturbed, or corrupted parameter vector, where the vector E=[e₁, . . . , e_{N}]∈ [symbol] , E∈ε represents the error vector, where ε denotes the set of all possible N length vectors with Euclidean norm equal to R>0; i.e., ε={E:∥E∥₂=R}. Ŵ may also be denoted as a set by writing

$$\hat{W} = {\{ {w}_{j} + {e}_{j} \}}_{j = 1}^{N} .$$

Let ƒ_{Ŵ} denote a DNN with Ŵ as its model parameters. Thus, ƒ_{W} and ƒ_{Ŵ} denote two DNNs with the same architecture, meaning both the DNNs will have exactly similar structure with the same number of layers, same number of neurons per layer, exactly the same activation functions for each of the neurons and exactly the same connectivity between the neurons belonging to successive layers. However, both the DNNs will have different edge weights: the DNN denoted by ƒ_{W} is the DNN with its model parameters given by W=[w₁, . . . , w_{N}]^{T} and the DNN denoted by ƒ_{Ŵ} is the DNN with its model parameters given by

$$\hat{W} = W + E = {[ {w}_{1} + {e}_{1} , … , {W}_{N} + {e}_{N} ]}^{T} .$$

Implementations of the present disclosure measure the sensitivity of, or an overall tolerance range for, the model parameters W of ƒ_{W} based on the difference between the output value when the DNN employs the original parameters W and the output value when the DNN employs the perturbed parameters Ŵ, for the same set of unlabeled input data samples x={x₁, x₂ . . . , x_{K}}.

In other words, equivalently, the sensitivity of, or an overall tolerance range for, the model parameters W of ƒ_{W} is measured based on the difference between the output of DNN ƒ_{W} and the output of DNN ƒ_{Ŵ} for the same set of unlabeled input data samples x={x₁, x₂, . . . , x_{K}}.

The sensitivity of, or an overall tolerance range for, the model parameters can be determined by solving the following optimization problem:

$${E}_{max} = arg {max}_{E ∈ {ℝ}^{N}} ( \frac{1}{K} {\sum }_{i = 1}^{K} {‖ {f}_{\hat{W}} ( {x}_{i} ) - {f}_{W} ( {x}_{i} ) ‖}_{p} ) < {L}_{th} \qquad \to Eqn . ( 1 )$$

Where, as stated earlier, ƒ_{Ŵ}(xᵢ) is the output/prediction/inference of the DNN ƒ_{Ŵ}, i.e., the DNN with Ŵ=W+E=[w₁+e₁, . . . , w_{N}+e_{N}]^{T} as its model parameters, for the input sample xᵢ and ƒ_{W} (xᵢ) is the output/prediction/inference of DNN ƒ_{W}, i.e., the DNN with W as its model parameters, for the input sample xᵢ and Lₜₕ is the acceptable level of degradation in the prediction/inference performance of the ML model.

In some aspects, ∥Z∥ₚ denotes p^{th} norm of Z (and Z may be a scalar or a vector). When p=2, it is Euclidean norm and p=2 may be employed. However, the value of p may suitably be chosen from case to case. Further, when Z is a scalar, its Euclidean norm is equal to its absolute value.

Solving the above optimization problem is equal to computing an N length error vector E such that the difference in the DNN output value with optimal parameters W and perturbed parameters W+E is within an acceptable limit, denoted by Lₜₕ. Such an error vector Eₘₐₓ would enable the node to derive a tolerance range Tₘₐₓ of the parameters of the ML model. Eₘₐₓ is the error vector that causes the maximum change in the performance of the ML model ƒ_{Ŵ} compared to the performance of the ML model ƒ_{W} without performance of the ML model degrading beyond the tolerance threshold value Lₜₕ.

If eᵢ, the i^{th} element of the error vector E has a higher magnitude, it implies that wᵢ, the i^{th} parameter of the ML model, has less influence on the ML model performance and hence, it has a lower sensitivity. On the other hand, if an element eᵢ of the error vector E has a lower magnitude, it implies that the i^{th} parameter of the ML model, wᵢ, it has, relatively, a higher sensitivity.

The optimization problem of Eqn. (1) can be solved in different ways. We describe herein one method of determining an approximate solution to this optimization problem, or equivalently an approximated version of such an error vector E, based on an iterative numerical approach which is based on the following mathematical reasoning.

Recall that ƒ_{Ŵ}(xᵢ) denotes the output/inference/prediction of DNN with Ŵ=[ŵ₁, . . . , ŵ_{N}]^{T} as its model, where Ŵ=W+E, where E=[e₁, . . . , e_{N}]E [symbol] , E∈ε represents the error vector, where ε denotes the set of all possible N length vectors with Euclidean norm equal to R>0; i.e., ε={E:∥E∥₂=R}.

Using Taylor expansion, first order approximation of ƒ_{Ŵ}(xᵢ)−ƒ_{W} (xᵢ) is given by (Ŵ−W)^{T}∇_{W}ƒ_{W} (xᵢ), where

$${∇}_{W} {f}_{W} ( {x}_{i} ) = \frac{\partial {f}_{W} ( {x}_{i} )}{\partial W} ( i . e . , {∇}_{W} {f}_{W} ( {x}_{i} )$$

is the gradient of ƒ_{W} (xᵢ) with respect to W). Thus,

$${f}_{\hat{W}} ( {x}_{i} ) - {f}_{W} ( {x}_{i} ) \approx {E}^{T} ( {∇}_{W} {f}_{W} ( {x}_{i} ) )$$

$$\frac{1}{K} {\sum }_{i = 1}^{K} {‖ {f}_{\hat{W}} ( {x}_{i} ) - {f}_{W} ( {x}_{i} ) ‖}_{p} \approx \frac{1}{K} {\sum }_{i = 1}^{K} {‖ {E}^{T} ( {∇}_{W} {f}_{W} ( {x}_{i} ) ) ‖}_{p}$$

With this background, an iterative numerical approach can be used to solve the optimization problem (of Eqn. (1)) to determine the error vector Eₘₐₓ from which, in some implementations, the tolerance range Tₘₐₓ of the DNN parameters can be determined.

### Inputs:

Optimal parameters W=[w₁, . . . , w_{N}]∈ [symbol] of the ML model.
Set of unlabeled data samples x={x₁, x₂, . . . , x_{K}}.
Step size Δ, where Δ>0 is a small positive value.
Tolerance threshold value Lₜₕ.
   Output: Vector Eₘₐₓ (an N×1 error vector indicating the sensitivity of the optimal ML model parameters)
(1) Initialize R=Δ
(2) The error vector Ê that results in highest loss, under the constraint that the Euclidean norm of the error vector is equal to R can be computed as follows:

$$\hat{E} = arg {max}_{E ∈ ε} \frac{1}{K} {\sum }_{i = 1}^{K} {‖ {E}^{T} ( {∇}_{W} {f}_{W} ( {x}_{i} ) ) ‖}_{2}$$

Where ε={E:∥E∥₂=R}, ∈⊂ [symbol] , is the set of all length N real valued vectors with Euclidean norm of each vector equal to R.
(3) Set Ŵ=W+Ê where a perturbed parameter vector Ŵ is generated by adding an error vector Ê to the parameter vector W, and compute

$$D = \frac{1}{K} {\sum }_{i = 1}^{K} {‖ {f}_{\hat{W}} ( {x}_{i} ) - {f}_{W} ( {x}_{i} ) ‖}_{2}$$

where:
ƒ_{W} (xᵢ) are output values of the ML model when the set of data samples x are input into the ML model having initial values w₁, . . . , w_{N} for the set of model parameters;
ƒ_{Ŵ}(xᵢ) are output values of the ML model when the set of data samples x are input into the ML model having values of the perturbed parameter vector Ŵ for the set of model parameters;
∥ƒ_{Ŵ}(xᵢ)−ƒ_{W} (xᵢ)∥_{z} are a set of difference values, each difference value being a norm of a difference between an output value ƒ_{Ŵ}(xᵢ) and a corresponding output value ƒ_{W} (xᵢ) for a respective data sample of the set of data samples; and
D is an average of the set of difference values;

```
(4) If D < Lₜₕ,
  • Increment R ← R + Δ
  • Eₘₑₘ = Ê
  • Go back to Step (2)
(5) If D = Lₜₕ,
  • OUTPUT Eₘₐₓ = Ê and STOP.
(6) If D > Lₜₕ,
  • OUTPUT Eₘₐₓ = Eₘₑₘ and STOP.
```

It can therefore be seen that the error vector Eₘₐₓ can be identified when the average of the set of difference values, D, equals or exceeds the tolerance threshold value Lₜₕ.

Whilst the iterative numerical procedure outlined above is described with reference to considering Euclidean norm, or, equivalently, L₂ norm to compute the set of difference values, the iterative numerical procedure can be generalized to work with any p-norm, where p≥1.

For an accurate estimate of the error vector Eₘₐₓ, and therefore the sensitivity or tolerance range of the ML model parameters, it is preferable that set of data samples x={x₁, x₂, . . . , xₙ} are independent and identically distributed (i.i.d) data samples with very similar statistical characteristics as that of the set of training data, [symbol] , used to develop the ML model.

The accuracy of the proposed method improves with the number of data points n in the data set x={x₁, x₂, . . . , xₙ}.

The node (which transfers the model parameters) may determine the tolerance threshold value Lₜₕ. Alternatively, the node may receive the tolerance threshold value Lₜₕ, or an indication of the tolerance threshold value Lₜₕ, from another node in the wireless communications system 100.

The node (which transfers the model parameters) nay determine initial value for the step size parameter Δ. Alternatively, the node may receive the initial value for the step size parameter Δ or an indication of the initial value for the step size parameter Δ from another node in the wireless communications system 100.

### Quantization

In some implementations of the present disclosure, the node (which transfers the model parameters) quantizes the model parameters based on the maximum change to the set of model parameters that is permitted without performance of the ML model degrading beyond a tolerance threshold value. In particular, the node quantizes the model parameters based on the error vector Eₘₐₓ.

In some implementations of the present disclosure, the node (which transfers the model parameters) determines a tolerance range Tₘₐₓ for the set of model parameters based on the set of data samples, the tolerance range defining a maximum change to the set of model parameters that is permitted without performance of the ML model degrading beyond the tolerance threshold value.

The maximum amount of change allowed in the parameters of the ML model, after quantization, is given by the norm of the error vector Eₘₐₓ. Thus, the maximum tolerance with a given tolerance threshold value Lₜₕ on the loss in performance, measured in terms of the Euclidean norm of the maximum permissible error vector, denoted by Tₘₐₓ, is given by:

$${T}_{max} = {‖ {E}_{max} ‖}_{2}$$

The node may be configured to quantize the set of model parameters based on the determined tolerance range Tₘₐₓ to generate quantized model parameters. In particular, having obtained the tolerance range Tₘₐₓ, the node performs quantization of the model parameters in such a way that ∥W^{q}−W∥₂≤Tₘₐₓ, where W^{q} is the quantized version of W; i.e.,

$${W}^{q} = {[ {w}_{1}^{q} , … , {W}_{N}^{q} ]}^{T}$$

is an N length vector containing the quantized parameter values

$${\{ {w}_{i}^{q} \}}_{1 = 1}^{N} ,$$

where

$${w}_{i}^{q}$$

is the quantized version of wᵢ.

The quantization described herein can be a scalar quantization, quantizing each parameter wᵢ individually as a scalar, or a vector quantizer that quantizes the vector W at once

The node may be configured to quantize each of the model parameters uniformly (e.g., with the same resolution), so that each of the model parameters is represented by the same number of bits, based on the determined tolerance range Tₘₐₓ.

Whilst the proposed method is described with reference to considering Euclidean norm, or, equivalently, L₂ norm of the error vector (i.e., ∥Eₘₐₓ∥₂). In fact, the proposed method can be generalized to work with any p-norm, i.e., ∥Eₘₐₓ∥ₚ, where p≥1. The accuracy of the estimated Tₘₐₓ may improve as the value of A becomes smaller.

In other implementations of the present disclosure, the node (which transfers the model parameters) performs unequal quantization of the model parameters based on the error vector Eₘₐₓ. In particular, each model parameter may be quantized differently based on its corresponding element in the error vector Eₘₐₓ. That is, the quantization that is performed is based on the sensitivity of each individual parameter of the ML model.

The node may be configured to compute an absolute value of each element in the error vector Eₘₐₓ; and if the absolute value of an element in the error vector is greater than a sensitivity threshold value denoted by Sₜₕ, declare a corresponding model parameter in the parameter vector as a non-sensitive model parameter; and if the absolute value of an element in the error vector is less than or equal to the sensitivity threshold value Sₜₕ, declare a corresponding model parameter in the parameter vector as a sensitive model parameter.

A higher value of |e_{max,i}| (absolute value of the i^{th} element in the vector Eₘₐₓ) indicates that the parameter wᵢ can tolerate a higher variation in its value, while keeping the performance of the ML model within the limit dictated by the threshold Lₜₕ. Such a parameter may be referred to as “non-sensitive” parameter. On the other hand, a low value of |e_{max,i}| indicates that it is required to safeguard the parameter wᵢ so that its value does not change much due to any kind of noisy/corrupt conditions (due to either hardware imperfections or due to the adverse channel) encountered during the transmission of these parameters over a wireless channel. Such a parameter may be referred to as a “sensitive” parameter.

Thus, based on the sensitivity threshold value, denoted by Sₜₕ, a model parameter wᵢ, i=1, . . . , N, can be declared as a sensitive parameter if the value of |e_{max,i}| is less than or equal to Sₜₕ. If the value of |e_{max,i}| is greater than Sₜₕ, then the corresponding parameter wᵢ is declared as non-sensitive parameter.

The node may then be configured to quantize the sensitive model parameters with a higher resolution than a resolution used to quantize the non-sensitive model parameters. In particular, the sensitive model parameters may be quantized with a high precision/high resolution quantizer, and the remaining non-sensitive model parameters may be quantized with a low precision/low resolution quantizer. In other words, sensitive model parameters are represented by a larger number of bits and the other (non-sensitive) parameters are represented with a lower number of bits.

It will be appreciated that in these other implementations, it is not necessary to compute the tolerance range Tₘₐₓ.

### Unequal Error Protection

In some implementations of the present disclosure, the node (which transfers the model parameters) performs unequal error protection to the model parameters. In particular, for each model parameter in the set of model parameters, the node is configured to determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond the tolerance threshold value Lₜₕ.

The unequal error protection may be based on the error vector Eₘₐₓ. In particular, the node may be configured to compute an absolute value of each element in the error vector; and if the absolute value of an element in the error vector is greater than a sensitivity threshold value denoted by Sₜₕ, declare a corresponding model parameter in the parameter vector as a non-sensitive model parameter; and if the absolute value of an element in the error vector is less than or equal to the sensitivity threshold value Sₜₕ, declare a corresponding model parameter in the parameter vector as a sensitive model parameter.

A higher value of |e_{max,i}| (absolute value of the 4th element in the vector Eₘₐₓ) indicates that the parameter wᵢ can tolerate a higher variation in its value, while keeping the performance of the ML model within the limit dictated by the threshold Lₜₕ. Such a parameter may be referred to as “non-sensitive” parameter. On the other hand, a low value of |e_{max,i}| indicates that it is required to safeguard the parameter wᵢ so that its value does not change much due to any kind of noisy/corrupt conditions (due to either hardware imperfections or due to the adverse channel) encountered during the transmission of these parameters over a wireless channel. Such a parameter may be referred to as a “sensitive” parameter.

Thus, based on the sensitivity threshold value, denoted by Sₜₕ, a model parameter wᵢ, i=1, . . . , N, can be declared as a sensitive parameter if the value of |e_{max,i}| is less than or equal to Sₜₕ. If the value of |e_{max,i}| is greater than Sₜₕ, then the corresponding parameter wᵢ is declared as non-sensitive parameter.

During the model transfer, the error protection provided to the parameters through Forward Error Correction (FEC) can be optimized by providing higher protection to the highly sensitive parameters (i.e., those having a lower absolute value of e_{max,i}) by employing a lower rate code and relatively lower protection to the non-sensitive parameters by employing a higher rate codes. That is, a rate of the error control code for the sensitive model parameters is less than the rate of the error control code for the non-sensitive model parameters.

In any of the implementations described herein, the node (which transfers the model parameters) may determine the sensitivity threshold value Sₜₕ. Alternatively, the node may receive the sensitivity threshold value Sₜₕ or an indication of the sensitivity threshold value Sₜₕ from another node in the wireless communications system 100.

It will be appreciated that implementations of the present disclosure may be combined such that a node may perform both the quantization (by any of the methods described herein) and unequal error protection to model parameters of a ML model. For example, the node may be configured to (i) determine a maximum change to the set of model parameters that is permitted without performance of the ML model degrading beyond a tolerance threshold value; (ii) quantize the set of model parameters based on the determined maximum change to generate quantized model parameters; (iii) provide error protection to the model parameter based on the sensitivity of the model parameter, the sensitivity of the model parameter indicating a degree of toleration for a value of the model parameter to vary without performance of the ML model degrading beyond a tolerance threshold value; and (iv) transmit the error protected quantized model parameters to a further node. It will be appreciated that in implementations whereby the quantization of the model parameters is performed uniformly based on the determined tolerance range Tₘₐₓ, it will be necessary, for each quantized model parameter in the set of quantized model parameters, to determine a sensitivity of the model parameter. In implementations whereby (unequal) quantization is performed based on the sensitivity of each individual parameter of the ML model, the determination of the sensitivity of each model parameter will have already been performed and this information can also be used in the unequal error protection.

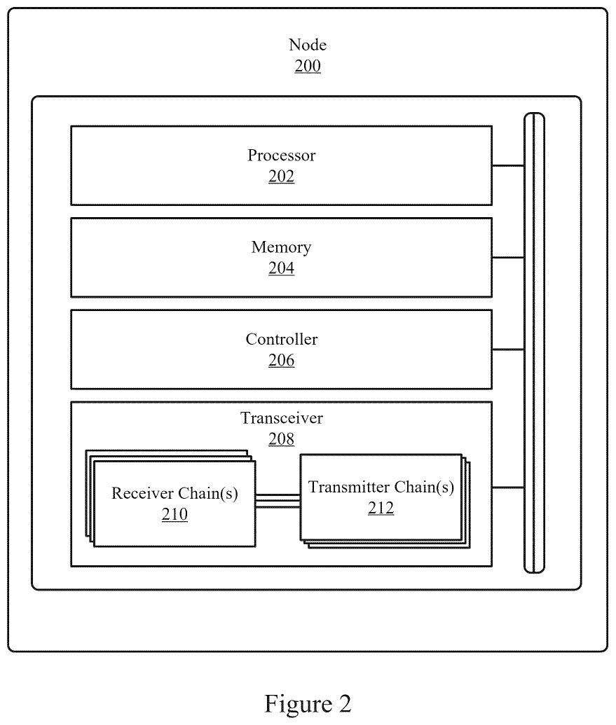

FIG. 2 illustrates an example of a node 200 in accordance with aspects of the present disclosure. In particular, the node 200 is configured to transmit model parameters of a ML model to a further node (second node). The node 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the node 200 to perform various functions of the present disclosure.

The memory 204 may include volatile or non-volatile memory. The memory 204 may store computer-readable, computer-executable code including instructions when executed by the processor 202 cause the node 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the node 200 to perform one or more of the functions described herein (e.g., executing, by the processor 202, instructions stored in the memory 204). For example, the processor 202 may support wireless communication at the node 200 in accordance with examples as disclosed herein. The node 200 may be configured to support a means for obtaining a machine learning (ML) model comprising of a set of model parameters; obtaining a set of data samples for inputting to the ML model; determining a maximum change to the set of model parameters that is permitted without performance of the ML model degrading beyond a tolerance threshold value; quantizing, based on the determined maximum change, the set of model parameters to generate quantized model parameters; and transmitting the quantized model parameters to a further node.

Alternatively or additionally, the node 200 may be configured to support a means for obtaining an ML model comprising of a set of model parameters; for each model parameter in the set of model parameters, determining a sensitivity of the model parameter, and providing error protection to the model parameter based on the sensitivity of the model parameter, the sensitivity of the model parameter indicating a degree of toleration for a value of the model parameter to vary without performance of the ML model degrading beyond a tolerance threshold value; and transmitting the error protected model parameters to a further node.

The controller 206 may manage input and output signals for the node 200. The controller 206 may also manage peripherals not integrated into the node 200. In some implementations, the controller 206 may utilize an operating system such as iOS®, ANDROID®, WINDOWS®, or other operating systems. In some implementations, the controller 206 may be implemented as part of the processor 202.

In some implementations, the node 200 may include at least one transceiver 208. In some other implementations, the node 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

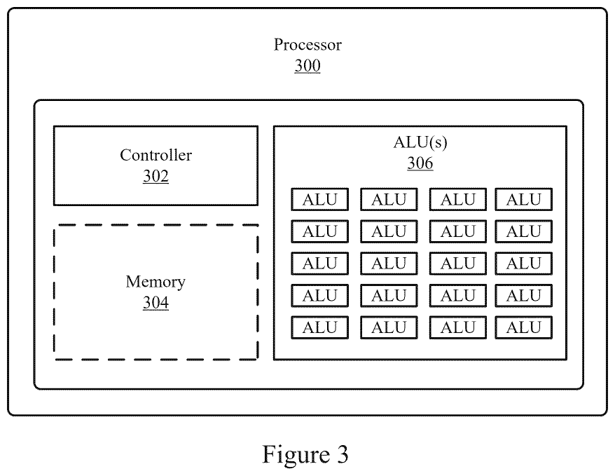

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for obtaining a machine learning (ML) model comprising of a set of model parameters; obtaining a set of data samples for inputting to the ML model; determining a maximum change to the set of model parameters that is permitted without performance of the ML model degrading beyond a tolerance threshold value; quantizing, based on the determined maximum change, the set of model parameters to generate quantized model parameters; and outputting the quantized model parameters for transmission to a further node.

Alternatively or additionally, the processor 300 may be configured to or operable to support a means for obtaining an ML model comprising of a set of model parameters; for each model parameter in the set of model parameters, determining a sensitivity of the model parameter, and providing error protection to the model parameter based on the sensitivity of the model parameter, the sensitivity of the model parameter indicating a degree of toleration for a value of the model parameter to vary without performance of the ML model degrading beyond a tolerance threshold value; and outputting the error protected model parameters for transmission to a further node.

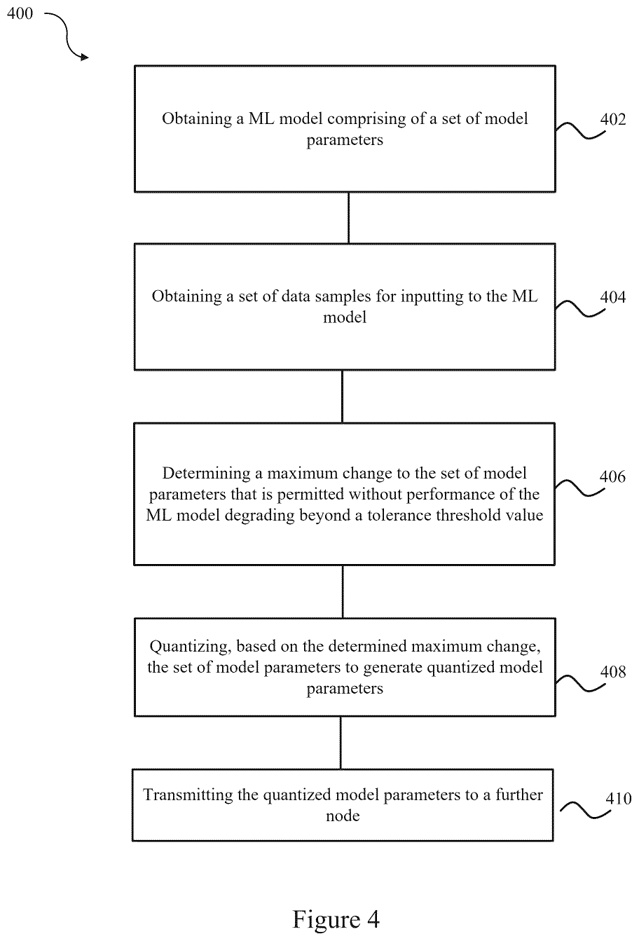

FIG. 4 illustrates a flowchart of a method 400 in accordance with aspects of the present disclosure. The operations of the method 400 may be implemented by a node as described herein (e.g., node 200), that is configured transmit model parameters of a ML model to a further node (second node). In some implementations, the node may execute a set of instructions to control the function elements of the node to perform the described functions.

At 402, the method 400 may include obtaining an ML model comprising of a set of model parameters. The operations of 402 may be performed in accordance with examples as described herein. In some implementations, aspects of the operations of 402 may be performed by a node as described with reference to FIG. 2.

At 404, the method 400 may include obtaining a set of data samples for inputting to the ML model. The operations of 404 may be performed in accordance with examples as described herein. In some implementations, aspects of the operations of 404 may be performed by a node as described with reference to FIG. 2.

At 406, the method 400 may include determining a maximum change to the set of model parameters that is permitted without performance of the ML model degrading beyond a tolerance threshold value. The operations of 406 may be performed in accordance with examples as described herein. In some implementations, aspects of the operations of 406 may be performed a node as described with reference to FIG. 2.

At 408, the method 400 may include quantizing, based on the determined maximum change, the set of model parameters to generate quantized model parameters. The operations of 408 may be performed in accordance with examples as described herein. In some implementations, aspects of the operations of 408 may be performed a node as described with reference to FIG. 2.

At 410, the method 400 may include transmitting the quantized model parameters to a further node. The operations of 410 may be performed in accordance with examples as described herein. In some implementations, aspects of the operations of 410 may be performed a node as described with reference to FIG. 2.

It can be seen that the determination of the tolerance range Tₘₐₓ and/or the sensitivity of each individual parameter of the ML model can be performed without training data and without labeled data. As described herein the determination of the error vector Eₘₐₓ (from which the tolerance range Tₘₐₓ and/or the sensitivity of each individual parameter of the ML model can be derived) can be performed by considering the gradient of the learned function of the ML model.

It should be noted that the method 400 described herein describes a possible implementation, and that the operations and the steps may be rearranged or otherwise modified and that other implementations are possible.

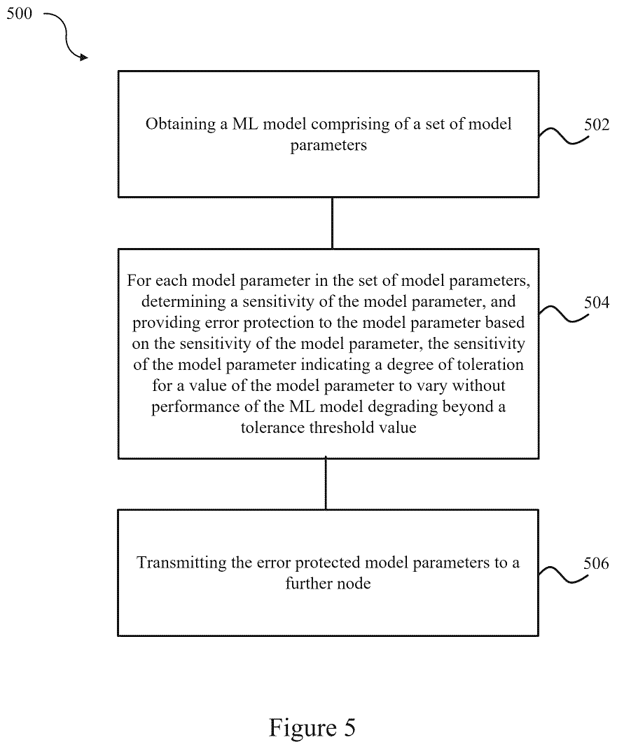

FIG. 5 illustrates a flowchart of another method 500 in accordance with aspects of the present disclosure. The operations of the method 500 may be implemented by a node as described herein (e.g., node 200), that is configured transmit model parameters of a ML model to a further node (second node). In some implementations, the node may execute a set of instructions to control the function elements of the node to perform the described functions.

At 502, the method 500 may include obtaining an ML model comprising of a set of model parameters. The operations of 502 may be performed in accordance with examples as described herein. In some implementations, aspects of the operations of 502 may be performed by a node as described with reference to FIG. 2.

At 504, the method 500 may include, for each model parameter in the set of model parameters, determining a sensitivity of the model parameter, and providing error protection to the model parameter based on the sensitivity of the model parameter, the sensitivity of the model parameter indicating a degree of toleration for a value of the model parameter to vary without performance of the ML model degrading beyond a tolerance threshold value. The operations of 504 may be performed in accordance with examples as described herein. In some implementations, aspects of the operations of 504 may be performed by a node as described with reference to FIG. 2.

At 506, the method 500 may include transmitting the error protected model parameters to a further node. The operations of 506 may be performed in accordance with examples as described herein. In some implementations, aspects of the operations of 506 may be performed a node as described with reference to FIG. 2.

It can be seen that unequal error protection for the model parameters is performed in the method 500 during model transfer over a wireless channel, by determining the sensitivity of each individual parameter of the ML model.

It should be noted that the method 500 described herein describes a possible implementation, and that the operations and the steps may be rearranged or otherwise modified and that other implementations are possible.

As noted herein, implementations of the present disclosure may be combined such that a node may perform both the quantization and unequal error protection to model parameters of a ML model. For example, step 504 may be implemented in the method 400 e.g., after step 408 such that the quantized model parameters transmitted at step 410 may be error protected in accordance with implementations of the present disclosure. In implementations whereby (unequal) quantization is performed at step 408 based on the sensitivity of each individual parameter of the ML model, the determination of the sensitivity of each model parameter of step 504 will have already been performed and this information can also be used in the unequal error protection.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A node for wireless communication, comprising:
at least one memory; and
at least one processor coupled with the at least one memory and operable to cause the node to:
obtain a machine learning (ML) model comprising of a set of model parameters;
for each model parameter in the set of model parameters, determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond a tolerance threshold value; and
transmit the error protected model parameters to a further node.

2. The node of claim 1, wherein the at least one processor is operable to:
determine first output values of the ML model when a set of data samples are input into the ML model having initial values for the set of model parameters;
arrange the initial values of the set of model parameters into a parameter vector;
generate a perturbed parameter vector by adding an error vector to the parameter vector;
determine second output values of the ML model when the set of data samples are input into the ML model having values of the perturbed parameter vector for the set of model parameters;
compute a set of difference values, each difference value being a norm of a difference between the second output value and the first output value for a respective data sample of the set of data samples;
compute an average of the set of difference values; and
if the average of the set of difference values equals or exceeds the tolerance threshold value:
the at least one processor is operable to compute an absolute value of each element in the error vector; and
if the absolute value of an element in the error vector is greater than a sensitivity threshold value, declare a corresponding model parameter in the parameter vector as a non-sensitive model parameter; and
if the absolute value of an element in the error vector is less than or equal to the sensitivity threshold value, declare a corresponding model parameter in the parameter vector as a sensitive model parameter.

3. The node of claim 2, wherein the at least one processor is operable to cause the node to:
error control code each model parameter in the set of model parameters with an error control code, wherein a rate of the error control code is determined based on whether the model parameter is a sensitive model parameter or a non-sensitive model parameter.

4. The node of claim 3, wherein a rate of the error control code for the sensitive model parameters is less than the rate of the error control code for the non-sensitive model parameters.

5. The node of claim 2, wherein a norm of the error vector is equal to a step size parameter, and if the average of the set of difference values is less than the tolerance threshold value, the at least one processor is operable to increase the value of the step size parameter.

6. The node of claim 5, wherein the at least one processor is operable to determine an initial value for the step size parameter.

7. The node of claim 5, wherein the at least one processor is operable to receive an initial value for the step size parameter or an indication of an initial value for the step size parameter, from another node.

8. The node of claim 5, wherein the norm of the error vector is an Euclidean norm.

9. The node of claim 1, wherein the at least one processor is operable to determine the tolerance threshold value.

10. The node of claim 1, wherein the node is configured to receive the tolerance threshold value or an indication of the tolerance threshold value, from another node.

11. The node of claim 2, wherein the at least one processor is operable to determine the sensitivity threshold value.

12. The node of claim 2, wherein the at least one processor is operable to receive the sensitivity threshold value or an indication of the sensitivity threshold value, from another node.

13. The node of claim 1, wherein the node is a user equipment, network equipment or a server.

14. The node of claim 2, wherein the set of data samples are unlabeled.

15. A processor for wireless communication, comprising:
at least one controller coupled with at least one memory and operable to cause the processor to:
obtain a machine learning (ML) model comprising of a set of model parameters;
for each model parameter in the set of model parameters, determine a sensitivity of the model parameter, and provide error protection to the model parameter based on the sensitivity of the model parameter, the sensitivity of the model parameter indicating a degree of toleration for a value of the model parameter to vary without performance of the ML model degrading beyond a tolerance threshold value; and
output the error protected model parameters for transmission to a further node.

16. A method performed at a node, the method comprising:
obtaining a machine learning (ML) model comprising of a set of model parameters;
for each model parameter in the set of model parameters, determining a sensitivity of the model parameter, and providing error protection to the model parameter based on the sensitivity of the model parameter, the sensitivity of the model parameter indicating a degree of toleration for a value of the model parameter to vary without performance of the ML model degrading beyond a tolerance threshold value; and
transmitting the error protected model parameters to a further node.

17. The method of claim 16, the method comprising:
determining first output values of the ML model when a set of data samples are input into the ML model having initial values for the set of model parameters;
arrange the initial values of the set of model parameters into a parameter vector;
generate a perturbed parameter vector by adding an error vector to the parameter vector;
determine second output values of the ML model when the set of data samples are input into the ML model having values of the perturbed parameter vector for the set of model parameters;
compute a set of difference values, each difference value being a norm of a difference between the second output value and the first output value for a respective data sample of the set of data samples;
compute an average of the set of difference values; and
if the average of the set of difference values equals or exceeds the tolerance threshold value:
computing an absolute value of each element in the error vector; and
if the absolute value of an element in the error vector is greater than a sensitivity threshold value, declare a corresponding model parameter in the parameter vector as a sensitive model parameter; and
if the absolute value of an element in the error vector is less than or equal to a sensitivity threshold value, declare a corresponding model parameter in the parameter vector as a non-sensitive model parameter.

18. The method of claim 17, wherein the method further comprises:
error control coding each model parameter in the set of model parameters with an error control code, wherein a rate of the error control code is determined based on whether the model parameter is a sensitive model parameter or a non-sensitive model parameter.

19. The method of claim 18, wherein a rate of the error control code for the sensitive model parameters is less than for the non-sensitive model parameters.
